(19) United States
(12) Patent Application Publication
(10) Pub. No.: US 2010/0302761 A1
(43) Pub. Date: Dec. 2, 2010

(54) Mounting apparatus for undercabinet lighting fixture

(76) Inventor: Sanford H. Benensohn, Valencia, CA (US)

Correspondence Address: Michael A. Painter, Esq., Suite 850, 8484 Wilshire Boulevard, Beverly Hills, CA, 90211, US

(21) Appl. No.: 12/455,255

(22) Filed: Jun. 1, 2009

(51) Int. Cl. F21V 33/00

(52) U.S. Cl. 362/133

(57) ABSTRACT

A mounting apparatus for undercabinet lighting fixtures that alternatively allows fixed or positionable coupling to the cabinet surface. An undercabinet lighting fixture is provided with an upper member having an opening disposed therein and within which a fixture mounting clip may be secured. The fixture mounting clip has a central bore therein for receiving a positionable pivot mounting bracket and apertures for alternatively securing the surface mounting clip to a cabinet surface. The pivot mounting bracket includes an upper flange for securing the pivot mounting bracket to a cabinet surface and an opposed resilient coupling adapted to be received within the central bore of the surface mounting clip.

### BACKGROUND OF THE INVENTION

1. Field of the Invention

The present invention generally relates to undercabinet lighting fixtures and particularly to a mounting apparatus that permits the undercabinet lighting fixture to be fixedly secured to a cabinet surface or be angularly pivoted to alter the direction of emitted light.

2. Prior Art

Undercabinet lighting fixtures are generally considered to be lighting fixtures that are mounted on the under-side of shelves to provide interior lighting within the cabinet enclosure. In one embodiment of undercabinet lighting fixtures taught by the prior art, a plurality of apertures are disposed through at least an upper member of the lighting fixture to provide openings through which fastening means such as screws or the like can be disposed into the cabinet surface to secure the lighting fixture to the cabinet surface in an unmoveable position. An inherent problem created by this structure is the inability to deflect or otherwise position the fixture to specifically direct emitted light to a selected area of the cabinet enclosure.

Another embodiment of an undercabinet lighting fixture taught by the prior art includes a pivoting arm that can be fixedly secured to a cabinet surface. When the pivoting arm is secured to the cabinet surface, the fixture can be rotated in a plane relative to the cabinet surface or can be deflected to direct emitted light to a selected area. A problem inherent in this design is that the fixture is displaced from the cabinet surface in a manner that restricts access within the cabinet enclosure.

The present invention resolves the problems inherent in the undercabinet lighting fixtures taught by the prior art. The present invention allows a user to either secure the undercabinet lighting fixture to the cabinet surface in an immovable position or, in the alternative, to permit the undercabinet lighting fixture to be pivotally coupled to the cabinet surface in a manner that will allow it to rotate 360° in a selected plane or to be angularly positioned relative to the cabinet surface to direct light to a selected area of the cabinet enclosure.

### SUMMARY OF THE INVENTION

The present invention comprises a mounting apparatus for an undercabinet lighting fixture which allows the undercabinet fixture to be either immovably secured to the underside of a cabinet shelf or surface or moveably secured and be pivotable in a plane relative to the shelf or cabinet surface and deflectable to enhance the light in a selected area of the cabinet enclosure. The mounting apparatus is comprised of a pivot mounting bracket that is adapted to be coupled to a fixture mounting clip. The pivot mounting bracket has an upper flange adapted to be secured to the underside of a cabinet shelf. Depending downwardly from the upper flange is a compressible fitting adapted to be movably engaged within a receiving aperture centrally disposed through the fixture mounting clip. When the compressible fitting is seated within the receiving aperture, the fixture mounting clip can be rotated about the access of the compressible fitting and also be deflected obliquely with respect to the axis of the compressible fitting.

The fixture mounting clip has at least two apertures disposed therethrough that can be used to immovably secure the fixture mounting clip directly to the undersurface of a cabinet shelf. A pair of parallel engagement flanges depend downwardly from the fixture mounting clip and are adapted to be coupled within a receiving aperture disposed in the upper member of the undercabinet lighting fixture. With the pivot mounting bracket pivotally coupled to the mounting clip, the undercabinet lighting fixture can be rotated and deflected with respect to the axis of the compressible fitting to direct the light at a selected area within the cabinet enclosure. With the pivot mounting bracket disengaged from the mounting clip, the lighting fixture can be fixedly secured to the undersurface of the cabinet shelf.

It is an object of the present invention to provide an improved design for a mounting bracket for undercabinet lighting fixtures.

It is another object of the present invention to provide a mounting bracket for undercabinet lighting fixtures that will permit rotation of the lighting fixture in a plane horizontal to a cabinet surface.

It is still another object of the present invention to provide a mounting bracket for an undercabinet lighting fixture that permits the lighting fixture to be deflected relative to the plane of the cabinet surface to which it is secured.

It is still yet another object of the present invention to provide a mounting bracket for undercabinet lighting fixtures that is simple and inexpensive to fabricate.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWING

FIG. 1 is an exploded, assembly view illustrating the fixture mounting clip and pivot mounting bracket comprising the present invention mounting apparatus coupled to an exemplary undercabinet lighting fixture.

FIG. 2 is a top plan view of the pivot mounting bracket shown in FIG. 1.

FIG. 3 is a bottom plan view of the pivot mounting bracket shown in FIG. 1.

FIG. 4 is a side elevation view of the pivot mounting bracket shown in FIG. 1 illustrating the compressible fitting.

FIG. 5 is a top plan view of the fixture mounting clip shown in FIG. 1.

FIG. 6 is a bottom plan view of the fixture mounting clip shown in FIG. 1.

FIG. 7 is a side elevation view of the fixture mounting clip shown in FIG. 1.

FIG. 8 is an end elevation view of the fixture mounting clip shown in FIG. 1.

FIG. 9 is a cross-sectional view of the fixture mounting clip shown in FIG. 2 taken through line 9-9 of FIG. 5.

FIG. 10 is a perspective, partial cross-sectional view of the present invention mounting apparatus coupled to an upper member of the undercabinet lighting fixture shown in FIG. 1.

### DESCRIPTION OF THE PRESENTLY PREFERRED EMBODIMENT

The present invention generally comprises a mounting apparatus 10 that is comprised of a fixture mounting clip 11 that is adapted to engage a pivot mounting bracket 12 in a manner that will permit fixture mounting clip 11 to be moved relative to pivot mounting bracket in a manner that will be described in detail hereinbelow. Mounting bracket 10 is adapted to be coupled to an undercabinet lighting fixture, an exemplary form thereof being generally designated by reference numeral 13.

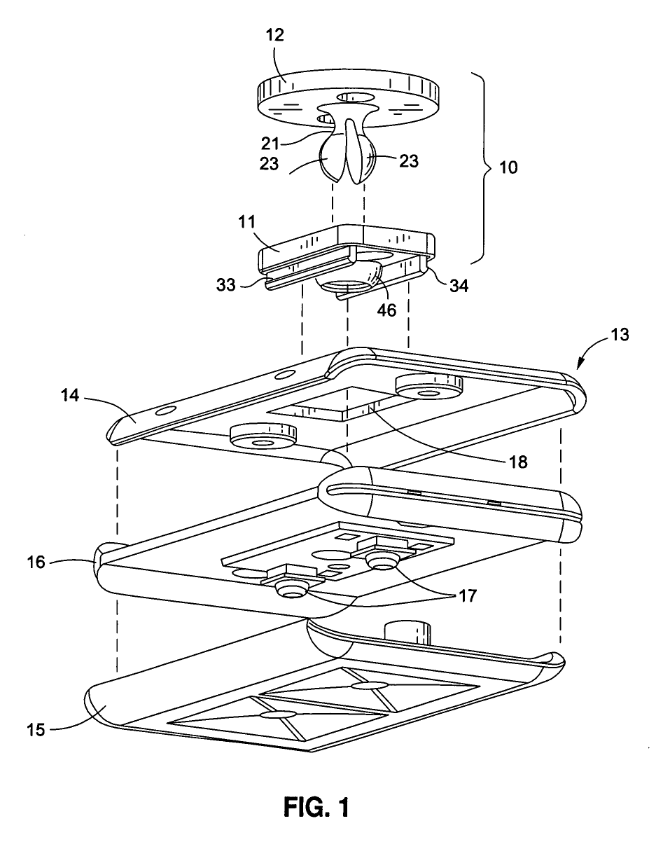

Undercabinet lighting fixtures are generally understood to be lighting fixtures that are secured within a cabinet on the undersurface of a shelf or other horizontal surface within a cabinet. Although an undercabinet lighting fixture in the form shown in FIG. 1 is used to explain the structure and function of the present invention, it is understood that other structural forms of undercabinet lighting fixtures that are adapted to be coupled to the present invention can be used. In order to couple undercabinet lighting fixture 13 to the present invention mounting apparatus 10, an aperture 18 is disposed through upper member 14 of undercabinet lighting fixture 13 which, as will be described in detail hereinbelow, is adapted to receive and removably secure mounting clip 11 to upper member 13.

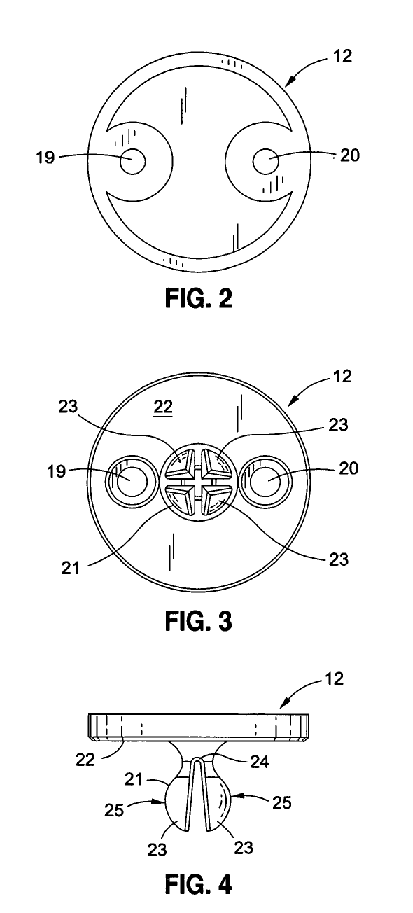

An understanding of the structure of pivot mounting bracket 12 can be best seen by reference to FIGS. 2, 3 and 4. Pivot mounting bracket 12 is a substantially planar member having a pair of spaced apertures 19 and 20 disposed therethrough for the purpose providing means for securing pivot mounting bracket 12 to the undersurface of a cabinet shelf or surface. A compressible fitting 21 extends downwardly from the bottom surface 22 of pivot mounting bracket 12 intermediate apertures 19 and 20. In the preferred embodiment of the present invention, compressible fitting 21 is formed of a plurality of space prongs 23 having inner surfaces that depend outwardly from the apex 24 to the bottom thereof. The outer portions of prongs 23 form a generally ellipsoidal profile. When pressure is imposed on prongs 23 in the directions indicated by reference numerals 25, the outer circumference of the ellipse formed by portions 23 will be resiliently compressed. As described in detail hereinbelow, the compressibility of prongs 23 will permit pivot mounting bracket 12 to be slidably coupled to fixture mounting clip 11.

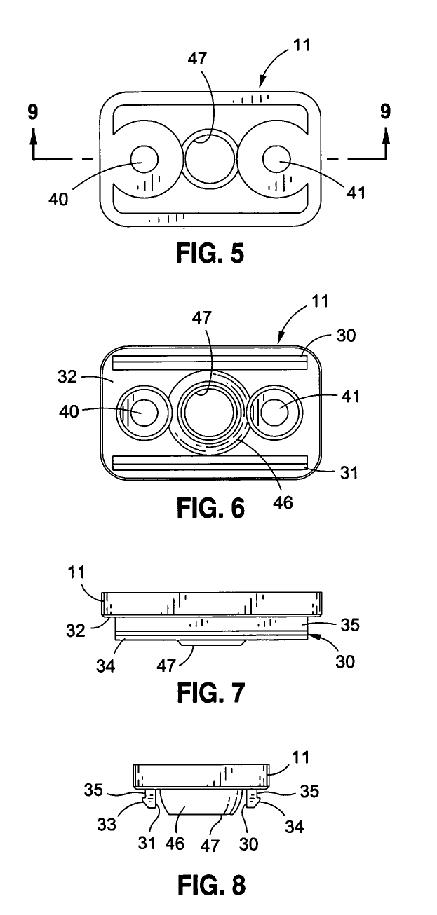

Fixture mounting clip 11 is the structural interface between pivot mounting bracket 12 and undercabinet lighting fixture 13. As can be seen in FIG. 1, an aperture 18 is disposed through upper member 14 of undercabinet lighting fixture 13. Although FIG. 1 illustrates aperture 18 as being rectangular, it is understood that other geometrical configurations can be used. To secure fixture mounting clip 11 to upper member 14, a pair of parallel spaced engagement flanges 30 and 31 depend downwardly from the bottom surface 32 of fixture mounting clip 11. As can be seen best in FIGS. 5 and 8, each engagement flange 30 and 31 uniformly extends downwardly from bottom surface 32 and depends outwardly into locking surfaces 33 and 34, respectively which extend fully along the engagement flanges 30 and 31 parallel to the bottom surface 32 of fixture mounting clip 11. The distance 35 between the bottom surface 32 of fixture mounting clip 11 and locking members 33 and 34 is approximately the thickness of upper member 14. Engagement flanges 30 and 31 are sufficiently resilient to permit them, when inserted into aperture 18, to be deflected and then positioned adjacent the parallel surfaces of aperture 18 with locking members 33 and 34 securing fixture mounting clip 11 in place within aperture 18.

As stated hereinabove, it is an objective of the present invention to provide a mounting apparatus that will permit an undercabinet lighting fixture to be either removably secured to a cabinet surface directly or in a manner that will permit it to be pivoted and deflected to direct light to a selected area of the cabinet enclosure. This objective can be met solely through the coupling of fixture mounting clip 11 and undercabinet lighting fixture 13. As can be best seen in FIGS. 5, 6 and 9, a pair of spaced apertures 40 and 41 are disposed through fixture mounting clip 11 from the lower surface 32 to the upper surface 42. A cavity 43 is formed intermediate apertures 40 and 41. As will be described in detail hereinbelow, in order to assemble the embodiment of the present invention which permits positioning of the undercabinet lighting fixture 13, cavity 43 is formed within fixture mounting clip 11 intermediate apertures 40 and 41. As will be described in detail hereinbelow, cavity 43 is adapted to receive prongs 23 of compressible fitting 21. To secure fixture mounting clip 11 and a coupled undercabinet lighting fixture 13 to a cabinet surface, fastening means preferably in the form of screws (not shown) are disposed through apertures 40 and 41 into the underside of the cabinet shelf or surface and tightened until the heads thereof are firmly seated in recessed detents 44 and 45.

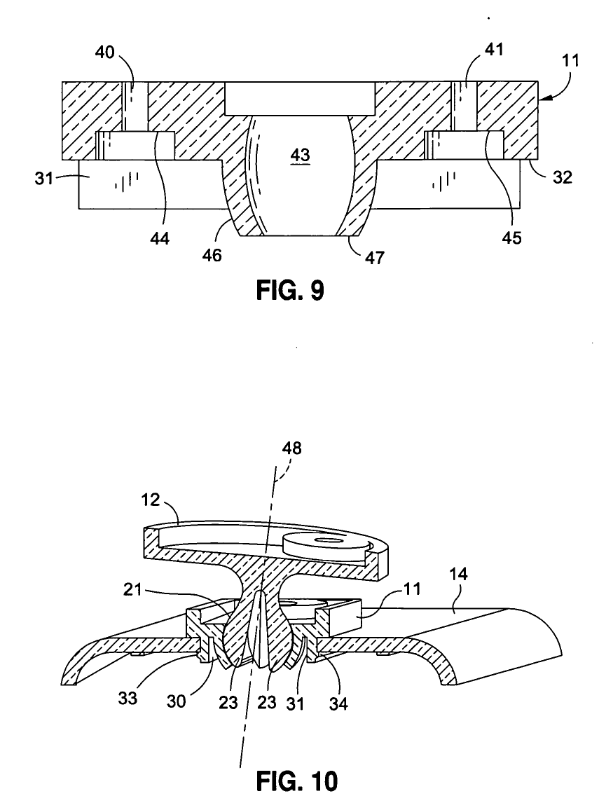

As stated hereinabove, it is an objective of the present invention to provide a mounting apparatus that will permit an undercabinet lighting fixture to be pivotally coupled to the underside of a cabinet shelf or surface in order to permit the light therefrom to be directed to a specific area in the cabinet enclosure. An understanding of the structure of the present invention that meets this objective can be best understood by reference to FIGS. 4-10, inclusive. Referring now to FIG. 9, the bottom surface 32 of mixture mounting clip 11 is deformed downwardly into a substantially elliptoid surface 46 creating a circular aperture at the lower terminus 47 thereof. Cavity 43 creates a surface that is in congruity with ellipsoidal surface 46 and, as set forth in detail hereinbelow, is adapted to be in sliding engagement with the compressible fitting 21 of pivot mounting bracket 12.

The assembly of fixture mounting clip 11, pivot mounting bracket 12 and the upper member 14 of undercabinet lighting fixture 13 can be best seen in FIGS. 1 and 9. Engagement flanges 30 and 31 are received within the aperture (see FIG. 1) disposed through upper member 14 of undercabinet lighting fixture 13. Locking members 33 and 34 secure fixture mounting clip 11 within the aperture in upper member 14. Because of the ellipsoidal surface of cavity 43, compression fitting 21 can be slidably engaged therewith by compressing prongs 23 inwardly in the direction shown by reference numeral 25 (see FIG. 4). When prongs 23 are released, compressible fitting 21 will be maintained in place within cavity 43 and moveable relative to fixture mounting clip 11. Since compressible fitting 21 is moveable relative to fixture mounting clip 11, upper member 14 of undercabinet lighting fixture 13 is rotatable about and deflectable with respect to axis 48 of pivot mounting bracket 12.

I claim:

1. A mounting apparatus for securing an undercabinet lighting fixture to the underside of a cabinet shelf or surface comprising:
(a) an undercabinet lighting fixture including an upper member having a top and a bottom surface having a uniform aperture disposed therethrough; and
(b) a fixture mounting clip comprising a planar member having top and bottom surfaces and a central, ellipsoidal cavity disposed therethrough from the top to the bottom surface and at least one aperture disposed through said planar member from the top to the bottom surface thereof adjacent said ellipsoidal cavity and clipping means for securing said fixture mounting clip to the upper member of said undercabinet lighting fixture, said clipping means being disposed within the aperture in the upper member of said undercabinet lighting fixture.

2. A mounting apparatus for securing an undercabinet lighting fixture to the underside of a cabinet shelf or surface as defined in claim 1 including a pivot mounting bracket comprising a uniform upper panel having top and bottom planar surfaces, a compressible fitting being disposed downwardly from the bottom surface of said pivot mounting bracket and being perpendicular thereto, said compressible fitting being slidably engageable within the ellipsoidal cavity of said fixture mounting clip whereby the undercabinet lighting fixture is moveable with respect to said pivot mounting bracket.

3. A mounting apparatus as defined in claim 1 wherein said clipping means comprises first and second engageable flanges in parallel spaced relation to each other depending downwardly from the bottom surface of said planar member of said fixture mounting clip, said engagement flanges each extending outwardly into opposed locking members adapted to engage the bottom surface of said upper member.

4. A mounting apparatus as defined in claim 2 including means for securing the upper panel of said pivot mounting bracket to the underside of a cabinet shelf or surface.

5. A mounting apparatus as defined in claim 1 wherein said compressible fitting comprises a plurality of uniformly spaced outwardly directed prongs disposed about an axis perpendicular to the bottom surface of said pivot mounting bracket, said prongs defining an ellipsoidal outer surface that is adapted to slidably engage the ellipsoidal cavity of said fixture mounting clip.

6. A mounting apparatus as defined in claim 2 wherein the upper panel of said pivot mounting bracket includes at least one aperture disposed from the top to the bottom surface thereof and fastening means for securing said pivot mounting bracket to the underside of a cabinet shelf or surface.

7. A mounting apparatus for securing an undercabinet lighting fixture to the underside of a cabinet shelf or surface comprising:
(a) an undercabinet lighting fixture including an upper member having a top and a bottom surface having a uniform aperture disposed therethrough;
(b) a fixture mounting clip comprising a planar member having top and bottom surfaces and a central, ellipsoidal cavity disposed therethrough from the top to the bottom surface and at least one aperture disposed through said planar member from the top to the bottom surface thereof adjacent said ellipsoidal cavity and clipping means for securing said fixture mounting clip to the upper member of said undercabinet lighting fixture, said clipping means being disposed within the aperture in the upper member of said undercabinet lighting fixture;
(c) a pivot mounting bracket comprising a uniform upper panel having top and bottom planar surfaces, a compressible fitting being disposed downwardly from the bottom surface of said pivot mounting bracket and being perpendicular thereto, said compressible fitting being slidably engageable within the ellipsoidal cavity of said fixture mounting clip whereby the undercabinet lighting fixture is moveable with respect to said pivot mounting bracket; and
(d) means for securing the upper panel of said pivot mounting bracket to the underside of a cabinet shelf or surface.

8. A mounting apparatus as defined in claim 7 wherein said clipping means comprises first and second engageable flanges in parallel spaced relation to each other depending downwardly from the bottom surface of said planar member of said fixture mounting clip, said engagement flanges each extending outwardly into opposed locking members adapted to engage the bottom surface of said upper member.

9. A mounting apparatus as defined in claim 7 wherein said compressible fitting comprises a plurality of uniformly spaced outwardly directed prongs disposed about an axis perpendicular to the bottom surface of said pivot mounting bracket, said prongs defining an ellipsoidal outer surface that is adapted to slidably engage the ellipsoidal cavity of said fixture mounting clip.

10. A mounting apparatus as defined in claim 7 wherein said means for securing the upper panel comprises at least one aperture disposed through the upper panel of said pivot mounting bracket and a fastening element disposed therethrough into said cabinet shelf or surface.
